(19) United States
(12) Patent Application Publication
(10) Pub. No.: US 2020/0104114 A1
(43) Pub. Date: Apr. 2, 2020

(54) INFORMATION PROCESSING APPARATUS, COMPUTER PROGRAM PRODUCT, AND INFORMATION PROCESSING SYSTEM

(71) Applicant: PANASONIC INTELLECTUAL PROPERTY MANAGEMENT CO., LTD., Osaka (JP)

(72) Inventors: Shotaro ARAKAWA, KANAGAWA KEN (JP); Tomohide UCHIMI, KANAGAWA KEN (JP); Yuta FURUKAWA, KANAGAWA KEN (JP); Kazuki ITO, TOKYO TO (JP); Takao NIHEI, KANAGAWA KEN (JP)

(73) Assignee: PANASONIC INTELLECTUAL PROPERTY MANAGEMENT CO., LTD., Osaka (JP)

(21) Appl. No.: 16/578,882

(22) Filed: Sep. 23, 2019

(30) Foreign Application Priority Data
Sep. 28, 2018 (JP) 2018-185750
Nov. 22, 2018 (JP) 2018-219612

(51) Int. Cl. G06F 8/65

(52) U.S. Cl. CPC G06F 8/65; B60R 16/0231

(57) ABSTRACT

An information processing apparatus according to an embodiment of the present disclosure includes a memory and a processor coupled to the memory. The processor is configured to acquire a drive state of a drive system that is provided with electronic devices, and control, based on the drive state of the drive system, program rewriting onto a target electronic device included in the electronic devices.

### CROSS-REFERENCE TO RELATED APPLICATIONS

This application is based upon and claims the benefit of priority from Japanese Patent Application No. 2018-185750, filed Sep. 28, 2018, and Japanese Patent Application No. 2018-219612, filed Nov. 22, 2018, the entire contents of which are incorporated herein by reference.

### FIELD

Embodiments described herein relate generally to an information processing apparatus, a computer program product, and an information processing system.

### BACKGROUND

It is known that there is a drive system driven by electronic devices, such as an electronic control unit (ECU) and the like, mounted on the drive system. Techniques relating to a system to rewrite a program of a particular electronic device are also known. In such system, a non-target electric device, which is not a target of program rewriting, is placed in a suspend state of data transmission to an in-vehicle network, and after that, program rewriting is carried out at a target electric device which is a target of the program rewriting (for example, Japanese Patent Application Laid-open Publication No. 2017-028523).

However, in the known techniques, functions of the non-target device are limited regardless of the drive state of the drive system. Thus, drive of the drive system during the program rewriting may also be limited.

### SUMMARY

An information processing apparatus according to an embodiment of the present disclosure includes a memory and a processor coupled to the memory. The processor is configured to acquire a drive state of a drive system that is provided with electronic devices, and control, based on the drive state of the drive system, program rewriting onto a target electronic device included in the electronic devices.

### BRIEF DESCRIPTION OF THE DRAWINGS

FIG. 1 is a schematic diagram of an information processing system according to a first embodiment of the present disclosure;

FIG. 2 is a hardware configuration diagram of an information processing apparatus according to the first embodiment;

FIG. 3 is a functional block diagram of a moving object according to the first embodiment and a second embodiment of the present disclosure;

FIG. 4A is a schematic diagram illustrating a data configuration of drive information according to the first embodiment;

FIG. 4B is a schematic diagram illustrating a data configuration of control information according to the first embodiment;

FIG. 5 is a flowchart of a procedure of information processing according to the first embodiment:

FIG. 6 is a schematic diagram illustrating a data configuration of control information according to the second embodiment; and

FIG. 7 is a flowchart of a procedure of information processing according to the second embodiment.

### DETAILED DESCRIPTION

The following describes embodiments of an information processing apparatus, a computer program product, and an information processing system according to the present disclosure with reference to the accompanying drawings.

### First Embodiment

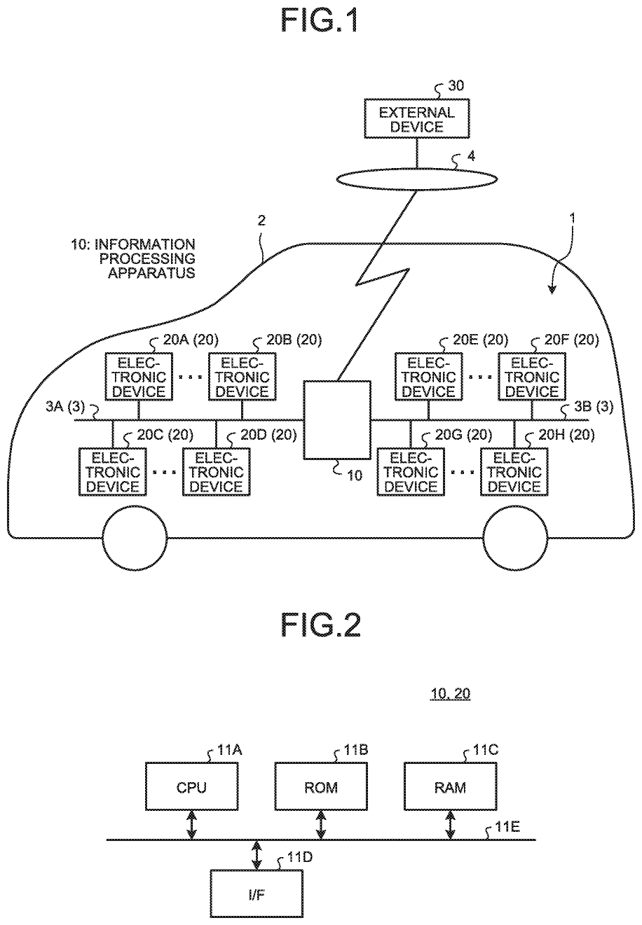

FIG. 1 is a schematic diagram illustrating an example of an information processing system 1 according to a first embodiment of the present disclosure. In the present embodiment, the information processing system 1 is mounted on a moving object 2.

The moving object 2 is an example of a drive system. The drive system is an apparatus that includes a drivable part. The drive system may be either a non-moving object immovable with respect to the ground or a moving object movable with respect to the ground.

Examples of the non-moving object may include robots, each being fixed to the ground and including a drivable part. Examples of the moving object may include vehicles (two-wheeled automobiles and four-wheeled automobiles), ships, and flying objects (airplanes, helicopters, airships, and drones).

In the present embodiment, an exemplary case will be described, in which the drive system is the moving object 2. The moving object 2 may be either a moving object that travels with interventions of driving operations by a person or a moving object that can automatically travel (autonomously travel) without the interventions of the driving operations by the person. In the present embodiment, it is assumed that the moving object 2 is a vehicle. In the present embodiment, it is also assumed that drive of the moving object 2 refers to a run of the vehicle. Note that the drive of the moving object 2 is not fixed to the run, and is simply required to represent that at least part of functions of the moving object 2 operates.

The information processing system 1 includes an information processing apparatus 10 and electronic devices 20. The information processing apparatus 10 is connected to the electronic devices 20 so as to carry out communications through a subnetwork 3.

The subnetwork 3 is a network provided in the moving object 2. When the moving object 2 is the vehicle, the subnetwork 3 may be called as an in-vehicle network. Multiple subnetworks 3 may be provided in the moving object 2. FIG. 1 illustrates, as an example, the structure in which a subnetwork 3A and a subnetwork 3B are provided in the moving object 2. The number of the subnetworks 3 disposed in the moving object 2 is not fixed to two.

The electronic devices 20 control various mechanisms mounted on the moving object 2.

Examples of the mechanisms mounted on the moving object 2 include an engine, motors, meters, a transmission, brakes, lamps, a power steering, an air conditioner, an audio system, and a navigation system of the moving object 2. The mechanisms include the ones related to the driving of the moving object 2. The mechanisms are not limited to such ones. The mechanisms are simply required to be mounted on the drive system of the moving object 2 and be controlled by the electronic devices 20.

The electronic devices 20 are provided with controllers. The controllers execute programs pre-installed on those controllers to perform control processing of predetermined mechanisms. The electronic devices 20 are, for example, electronic control units (ECUs). Specifically, the electronic devices 20 are, for example, an engine control device, a start-stop controller, a transmission control device, an airbag control device, a power steering control device, a navigation control device, a lane-keeping control device, and an inter-vehicle distance control device.

The electronic devices 20 control the mechanisms mounted on the moving object 2 through, for example, data communication with other electronic devices 20 through the subnetwork 3. The mechanisms are controlled by the electronic devices 20 to drive the moving object 2. In other words, the electronic devices 20 cooperate to control the mechanisms, such as the engine, the motors, and/or an accelerator, to drive the moving object 2.

The electronic devices 20 for controlling the mechanisms related to driving of the moving object 2 control the mechanisms so that the moving object 2 is able to drive in predetermined normal drive conditions. The term “normal drive conditions” refers to conditions that satisfy predetermined rules for, for example, driving range, driving force, speed limit, inter-vehicle distance, and lane-keeping. The normal drive conditions may be the ones that follow the predetermined rules, such as safety rules. The normal drive conditions may be set in advance at the time of, for example, production of the moving object 2. The normal drive conditions may be changeable as appropriate by, for example, an operational instruction by a user.

In FIG. 1, the information processing system 1 is provided with electronic devices 20A to 20H as the electronic devices 20, as an example. The number of the electronic devices 20 provided in the information processing system 1 is not fixed to that in the illustrated example.

The information processing apparatus 10 controls program rewriting onto each of the electronic devices 20 (described in detail later). In the present embodiment, as an example, a form will be described, in which the information processing apparatus 10 is mounted on a gateway device (hereinafter, abbreviated as “GW”) included in the information processing system 1.

The GW performs relay of communication between the subnetworks 3 (subnetworks 3A and 3B) in the information processing system 1 and relay of communication between the information processing system 1 and an external device 30 outside the moving object 2. In the present embodiment, the information processing apparatus 10 controls function as the GW in the information processing system 1, in addition to the program rewriting onto the electronic device 20.

The information processing apparatus 10 and the external device 30 are connected through an external network 4 to communicate with each other by, for example, wireless communication. The external network 4 is a network provided outside the moving object 2.

The information processing system 1 may be provided with the external device 30. In other words, the moving object 2 may include the external device 30.

In the present embodiment, a form will be described as an example, in which the external device 30 is disposed outside the moving object 2.

The following describes a hardware configuration.

FIG. 2 is an example of a hardware configuration diagram of the information processing apparatus 10.

The information processing apparatus 10 has the hardware structure in which, for example, a central processing unit (CPU) 11A, a read-only memory (ROM) 11B, a random access memory (RAM) 11C, and an interface (F) 11D are connected to one another by a bus 11E, and an ordinary computer is used.

The CPU 11A is an arithmetic device that controls the information processing apparatus 10 of the present embodiment. The ROM 11B stores, for example, a program for implementing various types of processing executed by the CPU 11A. The RAM 11C stores data required for the various types of processing executed by the CPU 11A. The I/F 11D is an interface for transmitting and receiving data.

The program for executing the information processing executed by the information processing apparatus 10 of the present embodiment is provided by being stored in, for example, the ROM 11B. The program to be executed by the information processing apparatus 10 of the present embodiment may be provided by being recorded, as a file in a format installable or executable on the information processing apparatus 10, on a computer-readable recording medium, such as a compact disc read-only memory (CD-ROM), a flexible disk (FD), a compact disc-recordable (CD-R), or a digital versatile disc (DVD).

The following describes a functional configuration of the information processing apparatus 10.

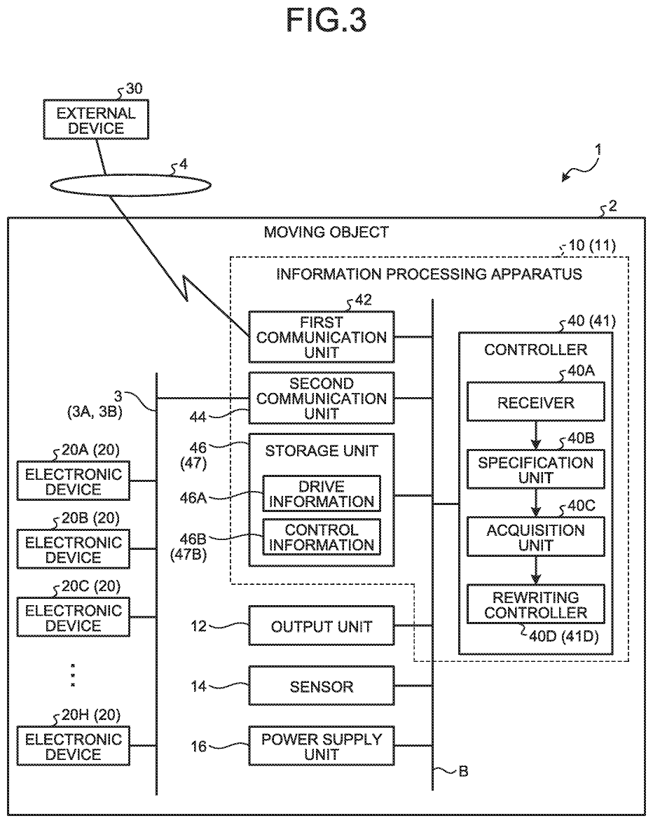

FIG. 3 is an example of a functional block diagram of the moving object 2 with the information processing apparatus 10 mounted thereon.

As described above, the moving object 2 is provided with the electronic devices 20 and the information processing apparatus 10. The moving object 2 is provided with an output unit 12, a sensor 14, and a power supply unit 16.

The output unit 12, the sensor 14, and the power supply unit 16 are connected to the information processing apparatus 10 so as to transmit and receive signals to/from one another.

The output unit 12 outputs various types of information. The output unit 12 may have, for example, a communication function to transmit the various types of information to devices, such as the external device 30, through the external network 4. The output unit 12 may also have a display function to display the various types of information, and/or a sound output function to output sound representing the various types of information. When the output unit 12 has the display function, the output unit 12 is provided with, for example, an organic electroluminescent (EL) display, a liquid crystal display (LCD), a projection device, or lights. When the output unit 12 has the sound output function, the output unit 12 is provided with a speaker.

The sensor 14 is a sensor that observes information on the moving object 2. In the present embodiment, the sensor 14 observes a drive state of the moving object 2. The drive state is information indicating “in drive” or “in drive stoppage”. The sensor 14 outputs the drive state as an observation result to the information processing apparatus 10.

The term “in drive” indicates that the moving object 2 is being driven. In detail, the term “in drive” indicates that drivable mechanisms in the moving object 2 are being driven. When the moving object 2 is the vehicle, the term “in drive” indicates that tires are rotationally driven by driving of the engine of the moving object 2, and thereby, the moving object 2 is traveling. In the present embodiment, a case as an example will be described, where the term “in drive” indicates that the moving object 2 is traveling.

The term “in drive stoppage” indicates that the drivable mechanisms in the moving object 2 are in a stop state. When the moving object 2 is the vehicle, the term “in drive stoppage” means that the moving object 2 has stopped traveling (that is, drive stoppage) by, for example, stopping the engine or driving the brakes of the moving object 2. In the present embodiment, a case as an example will be described, where the term “in drive stoppage” indicates the state that the moving object 2 has stopped traveling.

The sensor 14 is, for example, an inertial measurement unit (IMU), a speed sensor, or a Global Positioning System (GPS) sensor. The IMU may obtain triaxial accelerations and triaxial angular velocities of the moving object 2.

The power supply unit 16 supplies power to each of the electronic devices 20. The power supply unit 16 may supply the power to the electronic devices 20 by being controlled by the information processing apparatus 10 or the mechanisms provided on the moving object 2.

The following describes the functional configuration of the information processing apparatus 10. The information processing apparatus 10 is provided with a controller 40, a first communication unit 42, a second communication unit 44, and a storage unit 46. The controller 40, the first communication unit 42, the second communication unit 44, and the storage unit 46 are connected so as to transmit and receive data or signals to/from one another through a bus B.

The first communication unit 42 communicates with the external device 30 through the external network 4. The second communication unit 44 communicates with the respective electronic devices 20 through the subnetworks 3.

The storage unit 46 stores various types of data. The storage unit 46 is, for example, a semiconductor memory element such as a random access memory (RAM) or a flash memory, a hard disk, or an optical disc. The storage unit 46 may be a storage device provided outside the information processing apparatus 10. The storage unit 46 may also be a storage device provided outside the moving object 2. The storage unit 46 may also be a recording medium. Specifically, the recording medium may be a medium on which programs or various types of information are downloaded and stored or temporarily stored through, for example, a local area network (LAN) and the Internet. The storage unit 46 may also be constituted by recording media.

The controller 40 controls the information processing apparatus 10. In the present embodiment, the controller 40 executes processing to perform the function as the GW and controls the program rewriting onto the electronic device 20.

The controller 40 is provided with a receiver 40A, a specification unit 40B, an acquisition unit 40C, and a rewriting controller 40D.

Part or all of the receiver 40A, the specification unit 40B, the acquisition unit 40C, and the rewriting controller 40D may be implemented by, for example, causing a processor, such as the CPU 11A (See FIG. 2), to execute a program, that is, implemented by software. Alternatively, part of all of those may be implemented by hardware, such as an integrated circuit (IC), or by using both software and hardware.

The receiver 40A receives rewriting information. The rewriting information includes identification information on one of the electronic devices 20 that is a target of the program rewriting, a program, and a rewriting instruction signal. The identification information may be referred to as “ID” in the following description. In the following description, an electronic device 20 that is the target of the program rewriting may be referred to as a target electronic device 20. An electronic device 20, which is other than the target electronic device 20 and is not the target of the program rewriting, may be referred to as a non-target electronic device 20.

The term “program rewriting” means rewriting of at least part of a program installed on the electronic device 20. Specifically, the term “program rewriting” means installation of a new program that has been at least partially modified or changed on the electronic device 20. The new program installed on the electronic device 20 is the program included in the rewriting information.

In the present embodiment, the receiver 40A receives the rewriting information from the external device 30 through the first communication unit 42. The receiver 40A may receive the rewriting information by reading out the rewriting information from the storage unit 46.

During the program rewriting onto the target electric device 20 indicated by the identification information in the rewriting information, the specification unit 40B specifies whether the moving object 2 is normally drivable.

The term “normally drivable” indicates that the driving, which satisfies the above-described normal drive conditions, can be performed by the moving object 2. In contrast, the term “not normally drivable” indicates that the driving satisfying the above-described normal drive conditions cannot be performed by the moving object 2.

As described above, the moving object 2 is driven by that the electronic devices 20 cooperate to control the mechanisms related to the driving. The electronic device 20, on which the program rewriting is being performed, is difficult to control the mechanisms mounted on the moving object 2. This is because the electronic device 20 during the program rewriting is difficult to perform part of data transmission through the subnetworks 3. Hence, if the moving object 2 is driven during the program rewriting onto the target electric device 20, the mechanisms related to the drive of the moving object 2 are not normally controlled, and thus, the moving object 2 is difficult to be normally driven.

In the present embodiment, the specification unit 40B specifies whether or not the moving object 2 is normally drivable during the program rewriting onto the target electric device 20.

In the present embodiment, the specification unit 40B specifies, by using drive information 46A, whether or not the normal driving can be performed.

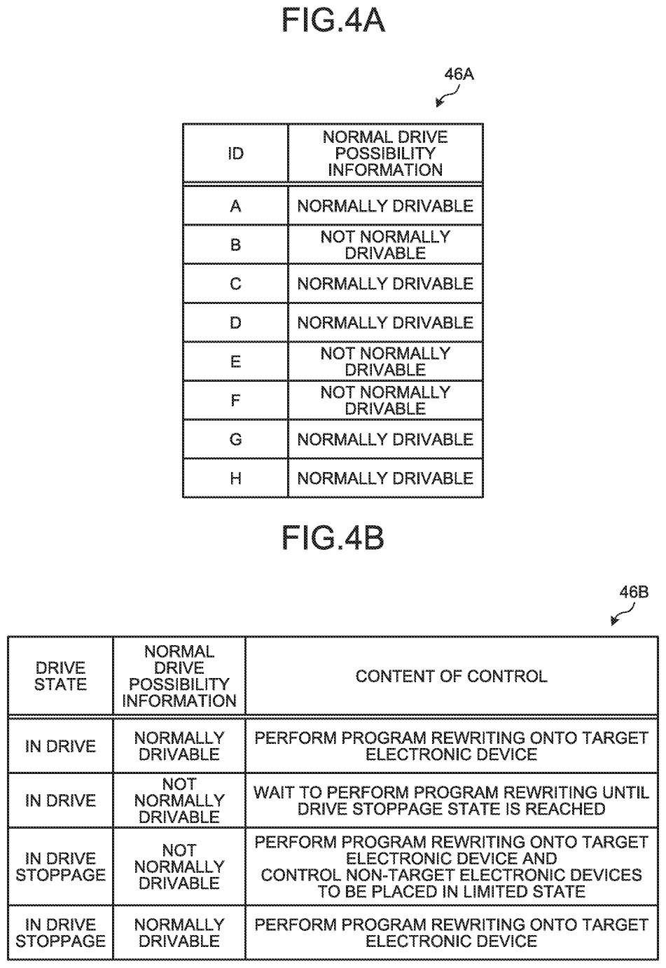

FIG. 4A is a schematic diagram illustrating an example of a data configuration of the drive information 46A. The drive information 46A is information, in which IDs of the electronic devices 20 are associated with normal drive possibility information.

The normal drive possibility information indicates whether the moving object 2 provided with an electronic device 20 is normally drivable while the program rewriting is performed onto this electronic devices 20 identified by the corresponding ID.

Specifically, the normal drive possibility information indicates whether the normal driving is possible or impossible. The expression “normal driving is possible” indicates that the moving object 2 is normally drivable even while the program rewriting is being performed onto the electronic device 20 identified by the corresponding ID. The expression “normal driving is impossible” indicates that the moving object 2 cannot be normally driven while the program rewriting is being performed onto the electronic device 20 identified by the corresponding ID.

The controller 40 may register in advance, into the drive information 46A, the normal drive possibility information corresponding to the ID on each of the electronic devices 20 mounted on the moving object 2. The drive information 46A may be changeable by, for example, an operational instruction by the user. The controller 40 may receive the drive information 46A from, for example, the external device 30 through the first communication unit 42, and store the received drive information 46A in the storage unit 46. The drive information 46A may be stored in the storage unit 46 at the manufacturing stage of the moving object 2.

The description will be continued with reference again to FIG. 3. The following describes processing of the acquisition unit 40C. The acquisition unit 40C acquires the drive state by acquiring an observation result of the drive state from the sensor 14. In other words, the acquisition unit 40C acquires the drive state representing whether the moving object 2 is “in drive” (that is, in travel) or “in stoppage” from the sensor 14.

The following describes processing of the rewriting controller 40D. The rewriting controller 40D controls the program rewriting onto the target electronic device 20, based on the drive state acquired by the acquisition unit 40C.

Specifically, the rewriting controller 40D controls the program rewriting onto the electronic device 20 identified by the ID in the rewriting information received by the receiver 40A, depending on which of “in drive” and “in stoppage” is represented by the drive state acquired by the acquisition unit 40C.

For example, when the drive state acquired by the acquisition unit 40C represents “in stoppage”, the rewriting controller 40D may control the target electronic device 20 to perform the program rewriting. When, in contrast, the drive state acquired by the acquisition unit 40C represents “in drive”, the rewriting controller 40D may control the target electronic device 20 to wait to perform the program rewriting.

The rewriting controller 40D may employ the following method of controlling the electronic device 20 to perform the program rewriting. For example, the rewriting controller 40D outputs the program and the rewriting instruction included in the rewriting information received by the receiver 40A to the target electronic device 20 through the second communication unit 44 and the subnetworks 3. In a processor of the electronic device 20 that has received the program the rewriting instruction, rewriting onto the program included in the rewriting information is performed by executing the rewriting to the received program. The rewriting controller 40D can control the electronic device 20 to perform the program rewriting through such processes.

Alternatively, the program rewriting may be performed by that the rewriting controller 40D carries out processing of installing the program included in the rewriting information onto the target electronic device 20. The method for controlling the electronic device 20 to perform the program rewriting is not restricted. In the following description, the expression “control the electronic device 20 to perform the program rewriting” may simply be expressed as “perform the program rewriting”.

The rewriting controller 40D may employ the following method to control the target electronic device 20 to wait to perform the program rewriting. For example, the rewriting controller 40D waits to output the program and the rewriting instruction included in the rewriting information received by the receiver 40A to the target electronic device 20 until the drive state acquired by the acquisition unit 40C turns to “in drive stoppage”. In this case, the rewriting controller 40D outputs the program and the rewriting instruction to the target electronic device 20 when the drive state turns to “in drive stoppage”.

The rewriting controller 40D may wait to install the program included in the rewriting information onto the target electronic device 20 until the drive state acquired by the acquisition unit 40C turns to “in drive stoppage”. The method for controlling the electronic device 20 to wait to perform the program rewriting is not restricted. In the following description, the expression “control the electronic device 20 to wait to perform the program rewriting” may simply be expressed as “wait to perform the program rewriting”.

It is preferable that the rewriting controller 40D controls the program rewriting onto the target electronic device 20, based on the drive state of the moving object 2 and information indicating whether the moving object 2 is normally drivable during the program rewriting onto the target electric device 20.

The following specifically describes the control performed by the rewriting controller 40D based on the combination of the drive state of the moving object 2 and information indicating whether the moving object 2 is normally drivable during the program rewriting onto the target electric device 20.

In the present embodiment, the rewriting controller 40D uses control information 46B to perform the following processing. The control information 46B may be stored in the storage unit 46 in advance.

FIG. 4B is a schematic diagram illustrating an example of a data configuration of the control information 46B. The control information 46B is information that associates the drive state with the normal drive possibility information and content of control. The rewriting controller 40D performs control, the content of which corresponding to the drive state and the normal drive possibility information in the control information 46B.

First, a case will be described, where the drive state of the moving object 2 represents “in drive” and the moving object 2 is specified to be normally drivable during the program rewriting onto the target electric device 20. This case corresponds to the uppermost record in the control information 46B illustrated in FIG. 4B. In this case, the rewriting controller 40D performs the program rewriting onto the target electronic device 20.

In this way, when the moving object 2 is specified to be normally drivable during the program rewriting onto the target electric device 20, the rewriting controller 40D performs the program rewriting onto the electronic device 20. As a result, the rewriting controller 40D can perform the program rewriting onto the target electronic device 20 while maintaining the drive satisfying the normal drive conditions of the moving object 2.

Here, in some cases, at least one of the electronic devices 20 mounted on the moving object 2 is placed in a limited state of function due to processing by the controller 40.

The term “limited state” refers to a state where at least part of functions of the electronic device 20 is limited. Specifically, the term “limited state” refers to a state where at least part of data transmission through the subnetworks 3 is limited or a state where the amount of power supply is limited to a predetermined value or lower.

For example, when the moving object 2 is in an idling mode, the electronic device 20, such as the power steering control device or the lane-keeping control device, stops, due to processing by the controller 40, execution of the power steering control or the lane-keeping control by stopping transmitting data or signals to the other electronic devices 20 through the subnetworks 3. Such stopped state corresponds to an example of the limited state. The state where the amount of power supply is limited to the predetermined value or lower is called a power saving mode, in some cases. The state of the power saving mode is, for example, an idle-stop state where the engine is stopped while the moving object 2 is in a stop state due to waiting at traffic lights. Accordingly, when at least part of the electronic device 20 is in the limited state, the moving object 2 is placed in the state of drive stoppage.

When the drive state of the moving object 2 represents “in drive” and the moving object 2 is normally drivable during the program rewriting onto the target electric device 20, the rewriting controller 40D may control the non-target electronic devices 20 to be placed in a released state of being released from the limited state of function.

In this way, the rewriting controller 40D controls the non-target electronic devices 20 of writing to be placed in the released state. As a result, the non-target electronic devices 20 functions normally when the moving object 2 is specified to be normally drivable during the program rewriting onto the target electric device 20 of writing. In this case, the rewriting controller 40D can restrain the limitation to the drive satisfying the normal drive conditions of the moving object 2.

The following describes a case where the drive state of the moving object 2 represents “in drive” and the moving object 2 is specified to be not normally drivable during the program rewriting onto the target electric device 20. This case corresponds to the second record in the control information 46B illustrated in FIG. 4B. In this case, the rewriting controller 40D waits to perform the program rewriting until the drive state turns to “in drive stoppage”.

When the drive state of the moving object 2 represents “in drive” and the moving object 2 is specified to be not normally drivable during the program rewriting onto the target electric device 20, it is preferable that the rewriting controller 40D outputs a specific message to the output unit 12. This message is, for example, a message indicating that the program rewriting onto the electronic device 20 will be performed after the moving object 2 stops driving.

The rewriting controller 40D displays the message on the output unit 12, for example. The rewriting controller 40D also outputs sound representing the message from the output unit 12. The user on board the moving object 2 can check the message by seeing or hearing the message. The rewriting controller 40D may also transmit the message to a terminal device operated by a predetermined user through the output unit 12 and the external network 4. The user operating the terminal device can understand, by checking the message received by the terminal device, that the program rewriting onto the electronic device 20 of the moving object 2 will be performed after the moving object 2 stops.

The following describes a case where the drive state of the moving object 2 represents “in drive stoppage” and the moving object 2 is specified to be not normally drivable during the program rewriting onto the target electric device 20. This case corresponds to the third record in the control information 46B illustrated in FIG. 4B.

In this case, the rewriting controller 40D performs the program rewriting onto the target electronic device 20, and the rewriting controller 40D controls the non-target electronic devices 20 to be placed in the limited state of being functionally limited during the program rewriting onto the target electric device 20. Since the definition of the functional limitation has been described above, the description will not be repeated.

In this way, when the moving object 2 is “in drive stoppage”, the rewriting controller 40D places the non-target electronic devices 20 in the limited state where data transmission to the subnetworks 3 is stopped, for example. As a result, it is capable of performing the program rewriting onto the target electronic device 20 while restraining the moving object 2 from being driven, such as traveling.

In addition, the non-target electronic devices 20 are restrained from transmitting the data to the subnetworks 3 by placing the non-target electronic devices 20 in the limited state. As a result, communication speeds of the subnetworks 3 can be restrained from decreasing during the program rewriting onto the target electric device 20. Therefore, the rewriting controller 40D can perform the program rewriting onto the target electronic device 20 in the state where delay in rewriting time is restrained.

When the drive state of the moving object 2 represents “in drive stoppage” and the moving object 2 is specified to be not normally drivable during the program rewriting onto the target electric device 20, it is preferable that the rewriting controller 40D outputs a predetermined message to the output unit 12.

This message may indicate that the program rewriting will be performed onto the electronic device 20 and the driving of the moving object 2 will be limited while the program rewriting is being performed. The rewriting controller 40D displays the message on the output unit 12, for example. The rewriting controller 40D also outputs sound representing the message from the output unit 12. The user on board the moving object 2 can check the message by seeing or hearing the message. The rewriting controller 40D may also transmit the message to the terminal device operated by the predetermined user through the output unit 12 and the external network 4.

The following describes a case where the drive state of the moving object 2 represents “in drive stoppage” and the moving object 2 is specified to be normally drivable during the program rewriting onto the target electric device 20. This case corresponds to the fourth record in the control information 46B illustrated in FIG. 4B.

In this case, the rewriting controller 40D performs the program rewriting onto the target electronic device 20.

Specifically, when the moving object 2 is “in drive stoppage” and the moving object 2 is normally drivable during the program rewriting onto the target electric device 20, the rewriting controller 40D performs the program rewriting onto the electronic device 20.

It is preferable that the rewriting controller 40D performs the following processing, when the drive state of the moving object 2 represents “in drive stoppage” and the moving object 2 is normally drivable during the program rewriting onto the target electric device 20. Specifically, it is preferable that the rewriting controller 40D controls the non-target electronic devices 20 to be placed in the limited state of being functionally limited during the program rewriting onto the target electric device 20.

At least one of the electronic devices 20 mounted on the moving object 2 is placed in a state of being shut off from the power supply, for example, by the controller 40 or through the control of the various mechanisms mounted on the moving object 2, in some cases.

Taking into consideration of such cases, when the target electronic device 20 is not being supplied with the power, it is preferable that the rewriting controller 40D controls the power supply unit 16 to start supplying the power to the electronic device 20 before the program rewriting is performed. Under the control of the rewriting controller 40D, the power supply unit 16 starts or resumes the power supply to the target electronic device 20 of the power supply.

The following describes a procedure of information processing performed by the controller 40.

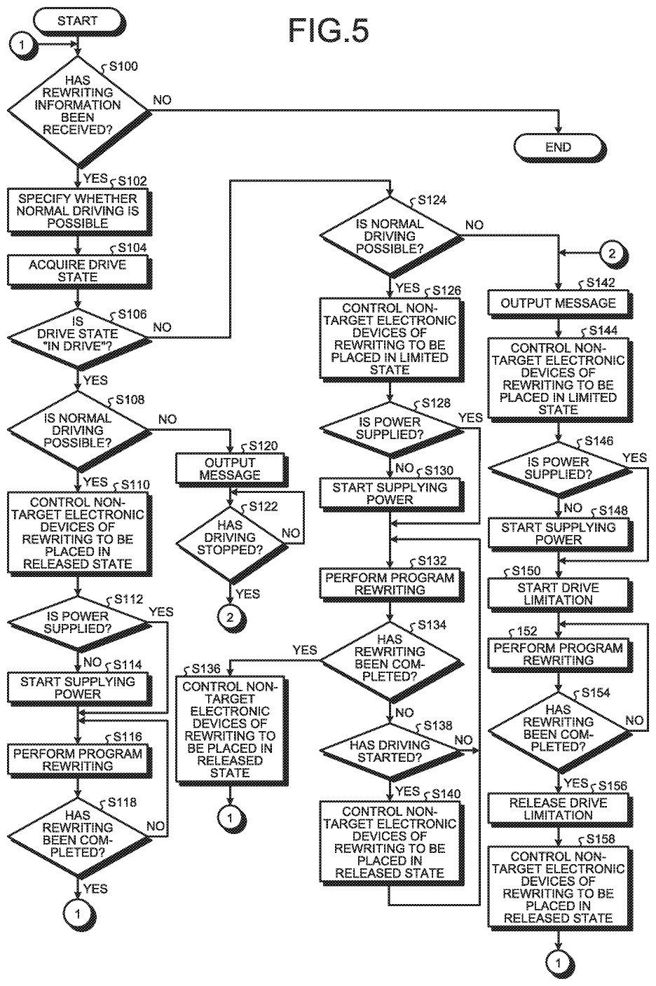

FIG. 5 is a flowchart of the procedure of the information processing performed by the controller 40 of the present embodiment.

First, the receiver 40A determines whether the rewriting information has been received (Step S100). When the determination is negative at Step S100 (No at Step S100), information processing is terminated. When the determination is affirmative at Step S100 (Yes at Step S100), processing is advanced to Step S102.

At Step S102, the specification unit 40B specifies whether or not the moving object 2 is normally drivable (Step S102). In detail, the specification unit 40B reads out, from the drive information 46A, the normal drive possibility information corresponding to the ID included in the rewriting information received at Step S100. By performing this processing, the specification unit 40B specifies whether the moving object 2 is normally drivable even when the program rewriting is being performed onto the target electric device 20 identified by the ID included in the rewriting information received at Step S100.

The acquisition unit 40C acquires the drive state of the moving object 2 (Step S104). Specifically, the acquisition unit 40C acquires the observation result of the drive state from the sensor 14.

The rewriting controller 40D determines whether or not the moving object 2 is “in drive” based on the observation result of the drive state acquired at Step S104 (Step S106).

When the moving object 2 is determined to be “in drive” (Yes at Step S106), processing is advanced to Step S108. At Step S108, the rewriting controller 40D determines whether the normal drive possibility specified at Step S102 indicates that the normal driving is possible (Step S108). When the normal drive possibility is determined to indicate that the normal driving is possible (Yes at Step S108), processing is advanced to Step S110.

At Step S110, the rewriting controller 40D controls the non-target electronic devices 20 to be placed in the released state (Step S110). In other words, the rewriting controller 40D controls the electronic devices 20, which are not the target electronic device 20 identified by the ID received at Step S100, to be placed in the released state of being released from the functional limitation.

The rewriting controller 40D determines whether or not the power is being supplied to the target electronic device 20 (Step S112). When the power is being supplied (Yes at Step S112), processing is advanced to Step S116 (described later). When the power is not being supplied (No at Step S112), processing is advanced to Step S114.

At Step S114, the rewriting controller 40D controls the power supply unit 16 to start supplying the power to the target electronic device 20 (Step S114). The processing at Step S114 supplies the power to the target electronic device 20. Then, processing is advanced to Step S116.

At Step S116, the rewriting controller 40D performs the program rewriting onto the target electronic device 20 (Step S116). The rewriting controller 40D then determines whether the program rewriting has been completed (Step S118). When the determination is negative at Step S118 (No at Step S118), processing is returned to Step S116. When, in contrast, the program rewriting is determined to have been completed (Yes at Step S118), processing is returned to the above-described Step S100.

At Step S108 described above, when the rewriting controller 40D determines that the normal drive possibility indicates that the normal driving is impossible (No at Step S108), processing is advanced to Step S120.

At Step S120, the rewriting controller 40D outputs the message to the output unit 12 (Step S120). The message indicates that, for example, the program rewriting onto the electronic device 20 will be performed after the moving object 2 stops driving, as described above.

Subsequently, the rewriting controller 40D determines whether the moving object 2 has stopped being driven (Step S122). At this Step S122, the rewriting controller 40D determines whether the observation result of the drive state newly acquired from the sensor 14 indicates “in drive stoppage”, and thus makes the determination at Step S122. The rewriting controller 40D repeats a negative determination (No at Step S122) until an affirmative determination is made at Step S122 (Yes at Step S122). When the determination is affirmative at Step S122 (Yes at Step S122), processing is advanced to Step S142 (described later).

At Step S106 described above, when the moving object 2 is determined to be “in drive stoppage” (No at Step S106), processing is advanced to Step S124.

At Step S124, the rewriting controller 40D determines whether the normal drive possibility specified at Step S102 indicates that the normal driving is possible (Step S124). When the normal drive possibility is determined to indicate that the normal driving is possible (Yes at Step S124), processing is advanced to Step S126.

At Step S126, the rewriting controller 40D controls the non-target electronic devices 20 to be placed in the limited state of being functionally limited (Step S126).

The rewriting controller 40D then determines whether the power is being supplied to the target electronic device 20 (Step S128). When the power is being supplied (Yes at Step S128), processing is advanced to Step S132 (described later). When the power is not being supplied (No at Step S128), processing is advanced to Step S130.

At Step S130, the rewriting controller 40D controls the power supply unit 16 to start supplying the power to the target electronic device 20 (Step S130). Then, the processing is advanced to Step S132.

At Step S132, the rewriting controller 40D performs the program rewriting onto the target electronic device 20 (Step S132). The rewriting controller 40D then determines whether the program rewriting has been completed (Step S134). When the determination is affirmative at Step S134 (Yes at Step S134), processing is advanced to Step S136.

At Step S136, the rewriting controller 40D controls the non-target electronic devices 20, which was controlled to be in the limited state at Step S126, to be placed in the released state (Step S136). Then, processing is returned to the above-described Step S100.

When the determination is negative at Step S134 (No at Step S134), processing is advanced to Step S138.

At Step S138, the rewriting controller 40D determines whether the moving object 2 has started to be driven (Step S138). The rewriting controller 40D makes the determination at Step S138 by determining whether the observation result of the drive state newly acquired from the sensor 14 indicates “in drive”. When the determination is negative at Step S138 (No at Step S138), processing is returned to the above-described Step S132. When the determination is affirmative at Step S138 (Yes at Step S138), processing is advanced to Step S140.

At Step S140, the rewriting controller 40D controls the non-target electronic devices 20 having been controlled to be in the limited state at Step S126 to be placed in the released state (Step S140). Then, processing is returned to the above-described Step S132.

At Step S124 described above, when the normal drive possibility is determined to indicate that the normal driving is impossible (No at Step S124), processing is advanced to Step S142.

At Step S142, the rewriting controller 40D outputs the message to the output unit 12 (Step S142). At this Step S142, the rewriting controller 40D outputs, to the output unit 12, the message indicating that, for example, the program rewriting will be performed onto the electronic device 20 and the driving of the moving object 2 will be limited while the program rewriting is performed.

Subsequently, the rewriting controller 40D controls the non-target electronic devices 20 to be placed in the limited state of being functionally limited (Step S144).

The rewriting controller 40D determines whether the power is being supplied to the target electronic device 20 (Step S146). When the power is being supplied (Yes at Step S146), processing is advanced to Step S150 (described later). When the power is not being supplied (No at Step S146), processing is advanced to Step S148.

At Step S148, the rewriting controller 40D controls the power supply unit 16 to start supplying the power to the target electronic device 20 (Step S148). Then, the processing is advanced to Step S150.

At Step S150, the rewriting controller 40D starts a drive limitation on the moving object 2 (Step S150). The rewriting controller 40D transmits instruction signals for limiting the travel of the moving object 2 to some of the electronic devices 20, which perform control related to the travel of the moving object 2, and to some of the mechanisms involved in the travel of the moving object 2. The drive of the moving object 2 is limited by those transmissions of the instruction signals.

At Step S152, the rewriting controller 40D performs the program rewriting onto the target electronic device 20 (Step S152). The rewriting controller 40D then determines whether the program rewriting has been completed (Step S154). When the determination is negative at Step S154 (No at Step S154), processing is returned to the above-described Step S152.

When the determination is affirmative at Step S154 (Yes at Step S154), processing is advanced to Step S156. At Step S156, the rewriting controller 40D releases the drive limitation on the moving object 2 started at Step S150 (Step S156). The processing at Step S156 places the moving object 2 in the state of being allowed to be driven, that is, to travel.

Subsequently, the rewriting controller 40D controls the non-target electronic devices 20, which was controlled to be in the limited state at Step S144, to be placed in the released state (Step S158). Then, processing is returned to the above-described Step S100.

As described above, the information processing apparatus 10 of the present embodiment is provided with the acquisition unit 40C and the rewriting controller 40D. The acquisition unit 40C acquires the drive state of the moving object 2 (drive system) provided with the electronic devices 20. Based on the drive state, the rewriting controller 40D controls the program rewriting onto the target electronic device 20 of the program rewriting included in the electronic devices 20.

Here, in the conventional art, the program rewriting onto the target electronic device 20 is performed after the functions of the non-target electronic devices 20 are limited regardless of the drive state of the moving object 2. As a result, when one or more electronic devices 20, which are involved in the drive control of the moving object 2, are included in the non-target electronic devices 20, the moving object 2 is difficult to perform the drive satisfying the normal drive conditions.

In contrast, the information processing apparatus 10 of the present embodiment performs the program rewriting onto the target electronic device 20 based on the drive state of the moving object 2.

Therefore, the information processing apparatus 10 of the present embodiment can perform or wait to perform the program rewriting onto the target electronic device 20 depending on the drive state of the moving object 2. For example, when the moving object 2 can perform the drive satisfying the normal drive conditions even while the program rewriting is being performed, the information processing apparatus 10 of the present embodiment can perform the program rewriting onto the target electronic device 20 without limiting the functions of the non-target electronic devices 20, even while the moving object 2 is being driven.

Accordingly, the information processing apparatus 10 of the present embodiment can restrain the drive limitation on the moving object 2 (drive system) being subjected to the program rewriting.

### Second Embodiment

A second embodiment of the present disclosure will be described, in which the program rewriting onto the target electronic device 20 and a restart of the electronic device 20 are controlled. In the present embodiment, the same configurations and functions as those of the foregoing first embodiment will be denoted by the same reference numerals, and detailed description thereof will not be given, in some cases.

The information processing system 1 of the present embodiment is provided with an information processing apparatus 11 (See FIG. 3) instead of the information processing apparatus 10.

The information processing apparatus 11 is provided with a controller 41, the first communication unit 42, the second communication unit 44, and a storage unit 47. The information processing apparatus 11 is provided with the controller 41 and the storage unit 47 instead of the controller 40 and the storage unit 46.

The storage unit 47 stores various types of data. In the present embodiment, the storage unit 47 stores the drive information 46A and control information 47B. In other words, the storage unit 47 stores the control information 47B instead of the control information 46B of the foregoing first embodiment. The control information 47B will be described in detail later.

The controller 41 is provided with the receiver 40A, the specification unit 40B, the acquisition unit 40C, and a rewriting controller 41D. In other words, the controller 41 is provided with the rewriting controller 41D instead of the rewriting controller 40D of the foregoing first embodiment.

In the same way as the rewriting controller 40D, the rewriting controller 41D controls the program rewriting onto the target electronic device 20 based on the drive state acquired by the acquisition unit 40C.

In the present embodiment, it is assumed that a memory area of each of the electronic devices 20 provided in the information processing system 1 includes a rewriting area and an execution area of a program. The rewriting area is part of the memory area and is used for rewriting a program installed on the electronic device 20. The execution area is part of the memory area and is used for loading and executing a program installed on the electronic device 20 at the time of execution of the program.

In order to load, after a program of the electronic device 20 is rewritten, the rewritten program in the execution area of the electronic device 20 to place the program in an executable state (that is, an active state), a restart of the electronic device 20 is required. When the memory area of the electronic device 20 includes the rewriting area and the execution area, the electronic device 20 can execute processing according to the program, which is already installed (but not yet rewritten) in the execution area of the memory area, even while the program is being rewritten at the rewriting area of the memory area.

Thus, in the present embodiment, the rewriting controller 41D controls the program rewriting onto the target electronic device 20 and the restart of the electronic device 20 based on the drive state of the moving object 2 and information on whether the moving object 2 is normally drivable during the program rewriting onto the target electric device 20. The restart may be called as reboot.

The following specifically describes the control by the rewriting controller 41D according to the combination of the drive state of the moving object 2 and whether the moving object 2 is normally drivable during the program rewriting onto the target electric device 20.

In the present embodiment, the rewriting controller 41D uses the control information 47B to perform the following processing. The control information 47B may be stored in the storage unit 47 in advance.

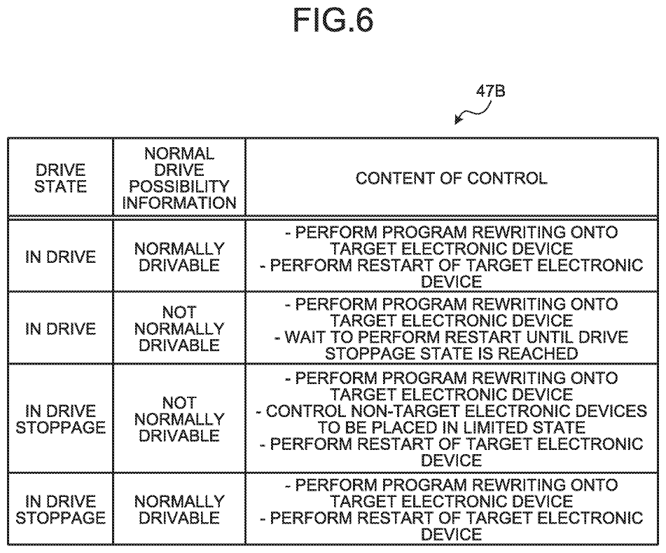

FIG. 6 is a schematic diagram illustrating an example of a data configuration of the control information 47B. The control information 47B is information, in which the drive state with the normal drive possibility information and the content of control are associated with each other. The rewriting controller 41D controls the control contents that correspond to the drive state and the normal drive possibility information in the control information 47B.

First, the case will be described, where the drive state of the moving object 2 represents “in drive” and the moving object 2 is specified to be normally drivable during the program rewriting onto the target electric device 20. This case corresponds to the uppermost record in the control information 47B illustrated in FIG. 6. In this case, the rewriting controller 41D performs the program rewriting onto the target electronic device 20. After the program rewriting onto the target electronic device 20 is completed, the rewriting controller 41D controls the electronic device 20 to perform the restart.

The rewriting controller 41D may control the electronic device 20 to perform the restart by means of the following method. For example, the rewriting controller 41D outputs a restart instruction to the target electronic device 20 through the second communication unit 44 and the subnetworks 3. The processor of the electronic device 20, which has received the restart instruction, restarts the electronic device 20 to perform the restart. By performing those processes, the rewriting controller 41D controls the electronic device 20 to perform the restart.

Alternatively, the rewriting controller 41D may perform the restart of the target electronic device 20 to control the electronic device 20 to perform the restart. The method for controlling the electronic device 20 to perform the restart is not restricted. In the following description, the expression “control the electronic device 20 to perform the restart” may simply be expressed as “perform the restart”.

In this way, when the moving object 2 is specified to be normally drivable during the program rewriting onto the target electric device 20, the rewriting controller 41D performs the program rewriting onto the electronic device 20 and performs the restart of the electronic device 20 after the program rewriting. As a result, the rewriting controller 41D can efficiently perform the program rewriting onto the target electronic device 20 while maintaining the drive satisfying the normal drive conditions of the moving object 2.

Note that, as in the controller 40 of the foregoing first embodiment, when the drive state of the moving object 2 represents “in drive” and the moving object 2 is normally drivable during the program rewriting onto the target electric device 20, the rewriting controller 41D may control the non-target electronic devices 20 to be placed in the released state of being released from the functional limitation.

The following describes the case where the drive state of the moving object 2 represents “in drive” and the moving object 2 is specified to be not normally drivable during the program rewriting onto the target electric device 20. This case corresponds to the second record in the control information 47B illustrated in FIG. 6.

In this case, the rewriting controller 41D controls the target electronic device 20 to perform the program rewriting, and controls the target electronic device 20 to wait to perform the restart until the program rewriting onto the target electronic device 20 is completed and the drive state turns to “in drive stoppage”.

For example, the rewriting controller 41D waits to output the restart instruction to the electronic device 20, on which the program rewriting has been completed, until the drive state acquired by the acquisition unit 40C turns to “in drive stoppage”. The rewriting controller 41D is simply required to output the restart instruction to the electronic device 20, on which the program rewriting has been completed, when the drive state turns to “in drive stoppage”.

In this way, when the drive state of the moving object 2 represents “in drive” and the moving object 2 is specified to be not normally drivable during the program rewriting onto the target electric device 20, the rewriting controller 41D controls the target electronic device 20 to perform the program rewriting in advance of the time when the drive state of the moving object 2 turns to “in drive stoppage”. When the drive state of the moving object 2 turns to “in drive stoppage” after the program rewriting onto the target electronic device 20 is completed, the rewriting controller 41D performs the restart of the electronic device 20.

Thus, the rewriting controller 41D can perform the program rewriting onto the target electronic device 20 without waiting until the drive state of the moving object 2 turns to “in drive stoppage”. Consequently, the rewriting controller 41D can efficiently perform the program rewriting onto the electronic device 20.

Note that, when the drive state of the moving object 2 represents “in drive” and the moving object 2 is specified to be not normally drivable during the program rewriting onto the target electric device 20, it is preferable that the rewriting controller 41D outputs a specific message to the output unit 12 when the program rewriting has been completed.

This message is a first message prompting to stop the moving object 2 or a second message indicating that the restart of the electronic device 20 will be performed when the moving object 2 is stopped.

The first message includes, for example, information indicating that the program rewriting onto the electronic device 20 has been completed and information representing the prompt to stop the moving object 2 in order to activate the program that has been rewritten. Specifically, the first message is, for example, “The program rewriting onto the electronic device 20 has been completed. Please stop the moving object 2 to activate the rewritten program.”.

The second message includes, for example, the information indicating that the program rewriting onto the electronic device 20 has been completed and the information indicating that the restart of the electronic device 20 will be performed when the moving object 2 is stopped. Specifically, the second message is, for example “The program rewriting onto the electronic device 20 has been completed. The restart of the electronic device 20 will be performed when the moving object 2 is stopped.”.

The rewriting controller 41D is simply required to output the first message or the second message to the output unit 12 depending on content of the rewritten program. For example, when the rewritten program has content with high urgency, the rewriting controller 41D outputs the first message to the output unit 12. When the rewritten program has content with low urgency, the rewriting controller 41D outputs the second message to the output unit 12. The determination on whether the urgency is high or low may be performed by using a predetermined criterion for the rewritten program.

The following describes the case where the drive state of the moving object 2 represents “in drive stoppage” and the moving object 2 is specified to be not normally drivable during the program rewriting onto the target electric device 20. This case corresponds to the third record in the control information 47B illustrated in FIG. 6.

In this case, the rewriting controller 41D controls the target electronic device 20 to perform the program rewriting, and controls the electronic device 20 to perform the restart when the program rewriting onto the electronic device 20 has been completed. Thus, the rewriting controller 41D can efficiently perform the program rewriting onto the electronic device 20.

The moving object 2 resumes the drive while the restart of the electronic device 20 is being performed by the rewriting controller 41D, in some cases. Taking into consideration of such cases, the rewriting controller 41D may start the drive limitation on the moving object 2 after completing the program rewriting onto the target electronic device 20. In the same way as the rewriting controller 40D of the foregoing first embodiment, the rewriting controller 41D transmits the instruction signals for limiting the travel of the moving object 2 to some of the electronic devices 20, which perform the control related to the travel of the moving object 2, and to some of the mechanisms involved in the travel of the moving object 2. This transmission of the instruction signals limits the drive, that is, the travel of the moving object 2. After starting the drive limitation, the rewriting controller 41D may control the electronic device 20 to perform the restart and release the drive limitation on the moving object 2 after the restart is completed.

In the same way as the rewriting controller 40D of the foregoing first embodiment, the rewriting controller 41D may control the non-target electronic devices 20 to be placed in the limited state of being functionally limited during the program rewriting onto the target electric device 20.

When the drive state of the moving object 2 represents “in drive stoppage” and the moving object 2 is specified to be not normally drivable during the program rewriting onto the target electric device 20, it is preferable that the rewriting controller 41D outputs a predetermined message to the output unit 12.

This message is, for example, a message indicating that the program rewriting will be performed onto the electronic device 20 and the driving of the moving object 2 will be limited until the restart of the electronic device 20 is completed after the program is rewritten. Specifically, this message may be “The program rewriting will be performed onto the electronic device 20. The travel of the moving object 2 will be limited until the rewriting is reflected.”.

The following describes the case where the drive state of the moving object 2 represents “in drive stoppage” and the moving object 2 is specified to be normally drivable during the program rewriting onto the target electric device 20. This case corresponds to the fourth record in the control information 47B illustrated in FIG. 6.

In this case, the rewriting controller 41D controls the target electronic device 20 to perform the program rewriting and to perform the restart when the program rewriting onto the electronic device 20 has been completed.

In other words, when the moving object 2 is “in drive stoppage” and the moving object 2 is normally drivable during the program rewriting onto the target electric device 20, the rewriting controller 41D performs the program rewriting onto the target electronic device 20 and performs the restart of the electronic device 20 after the program rewriting is completed. Thus, the rewriting controller 41D can efficiently perform the program rewriting onto the electronic device 20.

Note that, when the drive state of the moving object 2 represents “in drive stoppage” and the moving object 2 is normally drivable during the program rewriting onto the target electric device 20, it is preferable that the rewriting controller 41D controls the non-target electronic devices 20 to be placed in the limited state of being functionally limited during the program rewriting onto the target electric device 20, in the same way as the rewriting controller 40D of the foregoing first embodiment.

When the target electronic device 20 is not being supplied with the power, it is preferable that the rewriting controller 41D controls the power supply unit 16 to start supplying the power to the electronic device 20 before the program rewriting is performed, as in the rewriting controller 40D of the foregoing first embodiment.

The following describes a procedure of information processing performed by the controller 41.

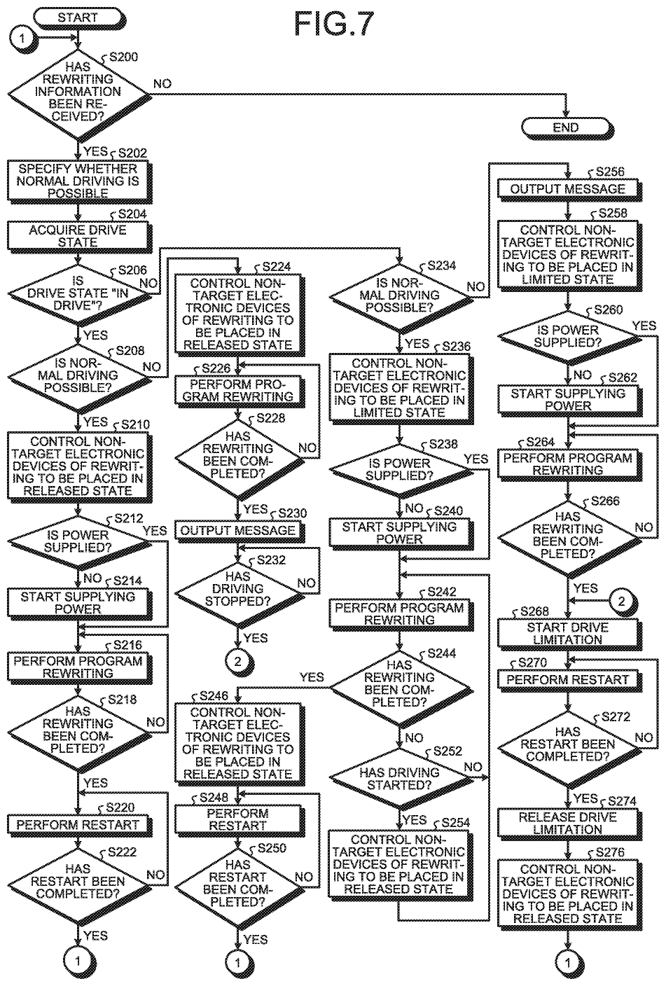

FIG. 7 is a flowchart of the procedure of the information processing performed by the controller 41 of the present embodiment.

The controller 41 performs processing at Steps S200 to S218 in the same way as Steps S100 to S118 of the foregoing first embodiment (See FIG. 5).

Specifically, the receiver 40A determines whether the rewriting information has been received (Step S200). When the determination is negative at Step S200 (No at Step S200), information processing is terminated. When the determination is affirmative at Step S200 (Yes at Step S200), processing is advanced to Step S202. At Step S202, the specification unit 40B specifies whether the moving object 2 is normally drivable (Step S202). The acquisition unit 40C acquires the drive state of the moving object 2 (Step S204).

Subsequently, based on the observation result of the drive state acquired at Step S204, the rewriting controller 41D determines whether the moving object 2 is “in drive” (Step S206). When the moving object 2 is determined to be “in drive” (Yes at Step S206), processing is advanced to Step S208. At Step S208, the rewriting controller 41D determines whether the normal drive possibility specified at Step S202 indicates that the normal driving is possible (Step S208). When the normal drive possibility is determined to indicate that the normal driving is possible (Yes at Step S208), processing is advanced to Step S210.

At Step S210, the rewriting controller 41D controls the non-target electronic devices 20 to be placed in the released state (Step S210). The rewriting controller 41D then determines whether the power is being supplied to the target electronic device 20 (Step S212). When the power is being supplied (Yes at Step S212), processing is advanced to Step S216 (described later). When the power is not being supplied (No at Step S212), processing is advanced to Step S214.

At Step S214, the rewriting controller 41D controls the power supply unit 16 to start supplying the power to the target electronic device 20 (Step S214). Then, the processing is advanced to Step S216. At Step S216, the rewriting controller 41D performs the program rewriting onto the target electronic device 20 (Step S216). The rewriting controller 41D then determines whether the program rewriting has been completed (Step S218). When the determination is negative at Step S218 (No at Step S218), processing is returned to the above-described Step S216. When, in contrast, the program rewriting is determined to have been completed (Yes at Step S218), processing is advanced to Step S220.

At Step S220, the rewriting controller 41D performs the restart of the target electronic device 20 onto which the program rewriting has been completed by the processing at Steps S216 to S218 (Step S220). The rewriting controller 41D then determines whether the restart of the electronic device 20 has been completed (Step S222). When the restart is determined to have not been completed (No at Step S222), processing is returned to the above-described Step S220. When the restart is determined to have been completed (Yes at Step S222), processing is returned to the above-described Step S200.

At Step S208 described above, when the rewriting controller 41D determines that the normal drive possibility indicates that the normal driving is impossible (No at Step S208), processing is advanced to Step S224.

At Step S224, the rewriting controller 41D controls the non-target electronic devices 20 to be placed in the released state (Step S224). The rewriting controller 41D then performs the program rewriting onto the target electronic device 20 (Step S226). The rewriting controller 41D then determines whether the program rewriting has been completed (Step S228). When the determination is negative at Step S228 (No at Step S228), processing is returned to the above-described Step S226. When, in contrast, the program rewriting is determined to have been completed (Yes at Step S228), processing is advanced to Step S230.

At Step S230, the rewriting controller 41D outputs the message to the output unit 12 (Step S230). As described above, this message is the first message prompting to stop the moving object 2 or the second message indicating that the restart of the electronic device 20 will be performed when the moving object 2 has stopped.

Subsequently, the rewriting controller 41D determines whether the moving object 2 has stopped being driven (Step S232). The determination at Step S232 is the same as that at Step S122 of the foregoing first embodiment described above (See FIG. 5). The rewriting controller 41D repeats a negative determination (No at Step S232) until an affirmative determination is made at Step S232 (Yes at Step S232). When the determination is affirmative at Step S232 (Yes at Step S232), processing is advanced to Step S268 (described later).

At Step S206 described above, when the moving object 2 is determined to be “in drive stoppage” (No at Step S206), processing is advanced to Step S234.

At Step S234, the rewriting controller 41D determines whether the normal drive possibility specified at Step S202 indicates that the normal driving is possible (Step S234). When the normal drive possibility is determined to indicate that the normal driving is possible (Yes at Step S234), processing is advanced to Step S236. The rewriting controller 41D performs processing at Steps S236 to S244 in the same way as Steps S126 to S134 of the foregoing first embodiment (See FIG. 5).

In more detail, the rewriting controller 41D controls the non-target electronic devices 20 to be placed in the limited state of being functionally limited (Step S236).

The rewriting controller 41D then determines whether the power is being supplied to the target electronic device 20 (Step S238). When the power is being supplied (Yes at Step S238), processing is advanced to Step S242 (described later). When the power is not being supplied (No at Step S238), processing is advanced to Step S240. At Step S240, the rewriting controller 41D controls the power supply unit 16 to start supplying the power to the target electronic device 20 (Step S240). Then, processing is advanced to Step S242.

At Step S242, the rewriting controller 41D performs the program rewriting onto the target electronic device 20 (Step S242). The rewriting controller 41D then determines whether the program rewriting has been completed (Step S244). When the determination is affirmative at Step S244 (Yes at Step S244), processing is advanced to Step S246.

At Step S246, the rewriting controller 41D controls the non-target electronic devices 20, which have been controlled to be in the limited state at Step S236, to be placed in the released state (Step S246).

The rewriting controller 41D performs the restart of the target electronic device 20 onto which the program rewriting has been completed by the processing at Steps S242 to S244 (Step S248). The rewriting controller 41D then determines whether the restart of the target electronic device 20 has been completed (Step S250). When the restart is determined to have not been completed (No at Step S250), processing is returned to the above-described Step S248. When the restart is determined to have been completed (Yes at Step S250), processing is returned to the above-described Step S200.

When the determination is negative at Step S244 (No at Step S244), processing is advanced to Step S252.

At Step S252, the rewriting controller 41D determines whether the moving object 2 has started to be driven (Step S252). The rewriting controller 41D determines whether the observation result of the drive state newly acquired from the sensor 14 indicates “in drive”, and thus makes the determination at Step S252. When the determination is negative at Step S252 (No at Step S252), processing is returned to the above-described Step S242. When the determination is affirmative at Step S252 (Yes at Step S252), processing is advanced to Step S254.

At Step S254, the rewriting controller 41D controls the non-target electronic devices 20 having been controlled to be in the limited state at Step S236 to be placed in the released state (Step S254). Then, processing is returned to the above-described Step S242.

When, at Step S234, the normal drive possibility is determined to indicate that the normal driving is impossible (No at Step S234), processing is advanced to Step S256.

At Step S256, the rewriting controller 41D outputs the message to the output unit 12 (Step S256). At Step S256, the rewriting controller 41D outputs, to the output unit 12, the message indicating, for example, that the program rewriting will be performed onto the electronic device 20 and the driving of the moving object 2 will be limited until the restart of the electronic device 20 is completed after the program is rewriting.

Subsequently, the rewriting controller 41D controls the non-target electronic devices 20 to be placed in the limited state of being functionally limited (Step S258). The rewriting controller 41D then determines whether the power is being supplied to the target electronic device 20 (Step S260). When the power is being supplied (Yes at Step S260), processing is advanced to Step S264 (described later). When the power is not being supplied (No at Step S260), processing is advanced to Step S262.

At Step S262, the rewriting controller 41D controls the power supply unit 16 to start supplying the power to the target electronic device 20 (Step S262). Then, processing is advanced to Step S264.

At Step S264, the rewriting controller 41D performs the program rewriting onto the target electronic device 20 (Step S264). The rewriting controller 41D then determines whether the program rewriting has been completed (Step S266). When the determination is negative at Step S266 (No at Step S266), processing is returned to the above-described Step S264.

When the determination is affirmative at Step S266 (Yes at Step S266), processing is advanced to Step S268. At Step S268, the rewriting controller 41D starts the drive limitation on the moving object 2 (Step S268). For example, the rewriting controller 41D transmits the instruction signals for limiting the travel of the moving object 2 to some of the electronic devices 20 that perform control related to the travel of the moving object 2, and to some of the mechanisms involved in the travel of the moving object 2. This transmission of the instruction signals limits the drive, that is, the travel of the moving object 2.

The rewriting controller 41D then performs the restart of the electronic device 20 onto which the program rewriting has been completed by the processing at Steps S264 to S266 (Step S270). The rewriting controller 41D then determines whether the restart of the electronic device 20 has been completed (Step S272). When the restart is determined to have not been completed (No at Step S272), processing is returned to the above-described Step S270. When the restart is determined to have been completed (Yes at Step S272), processing is advanced to Step S274.

At Step S274, the rewriting controller 41D releases the drive limitation on the moving object 2 started at Step S268 (Step S274).

Subsequently, the rewriting controller 41D controls the non-target electronic devices 20, which have been controlled to be in the limited state at Step S258, to be placed in the released state (Step S276). Then, processing is returned to the above-described Step S200.

As described above, the rewriting controller 41D of the information processing apparatus 11 according to the present embodiment controls the program rewriting onto the target electronic device 20 and the restart of the electronic device 20 based on the drive state of the moving object 2 and information on whether the moving object 2 is normally drivable during the program rewriting onto the target electric device 20.

Thus, in the present embodiment, even when the moving object 2 (drive system) is not normally drivable during the program rewriting onto the target electric device 20, the rewriting controller 41D can perform the program rewriting onto the electronic device 20 without waiting until the drive of the moving object 2 stops. The rewriting controller 41D can control the electronic device 20 to perform the restart depending on the drive state of the moving object 2 after the program rewriting is completed.

Therefore, the information processing apparatus 11 of the present embodiment can efficiently perform the program rewriting onto the electronic device 20, in addition to providing the effect of the foregoing first embodiment described above.

In each of the above-described embodiments, the information processing apparatus 10 or 11 is mounted on the gateway device (GW) included in the information processing system 1. Alternatively, the information processing apparatus 10 or 11 may be mounted on one of the electronic devices 20 included in the information processing system 1. In this case, the electronic device 20 provided with the information processing apparatus 10 or 11 are simply required to be capable of communicating with the external device 30 through the external network 4. The information processing apparatus 10 or 11 may be configured separately from the electronic device 20 and the gateway device. In this case, the information processing system 1 is simply required to include the information processing apparatus 10 or 11, the electronic devices 20, and the gateway device. When the information processing apparatus 10 or 11 is configured separately from the gateway device, the information processing system 1 is not required to include the gateway device.

In each of the above-described embodiments, the information processing apparatus 10 or 11 is mounted on the moving object 2. Alternatively, the information processing apparatus 10 or 11 may be provided outside the moving object 2. In this case, the information processing apparatus 10 or 11 is simply required to communicate with each of the electronic devices 20 mounted on the moving object 2 through the external network 4.

The program for performing the above-described information processing in the above-described embodiments is configured as modules including the functional units described above. As the concrete hardware, for example, the CPU (processor circuit) reads out the information processing program from the ROM or a hard disk drive (HDD), and executes the program to load the above-described functional units into the RAM (main memory) and generate the above-described functional units in the RAM (main memory). Part or all of the above-described functional units can be implemented by using dedicated hardware, such as an application-specific integrated circuit (ASIC) or a field-programmable gate array (FPGA).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a memory; and
a processor coupled to the memory and configured to
acquire a drive state of a drive system that is provided with electronic devices; and
control, based on the drive state of the drive system, program rewriting onto a target electronic device included in the electronic devices.

2. The information processing apparatus according to claim 1, wherein the processor performs the control of the program rewriting onto the target electronic device based on, in addition to the drive state of the drive system, information representing whether the drive system is normally drivable during the program rewriting onto the target electronic device.

3. The information processing apparatus according to claim 2, wherein, when the drive state represents that the drive system is in drive and the information represents that the drive system is normally drivable during the program rewriting onto the target electric device, the processor controls the target electronic device to perform the program rewriting.

4. The information processing apparatus according to claim 3, wherein, when the drive state represents that the drive system is in drive and the information represents that the drive system is normally drivable during the program rewriting onto the target electric device, the processor controls the target electronic device to perform a restart after the program rewriting onto the target electronic device is completed.

5. The information processing apparatus according to claim 3, wherein, when the drive state represents that the drive system is in drive and the information represents that the drive system is normally drivable during the program rewriting onto the target electric device, the processor controls a non-target electronic device in the electronic devices, which is in a limited state where a functional limitation is applied, to be placed in a released state of being released from the functional limitation.

6. The information processing apparatus according to claim 2, wherein, when the drive state represents that the drive system is in drive and the information represents that the drive system is not normally drivable during the program rewriting onto the target electric device, the processor controls the target electronic device to wait to perform the program rewriting until the drive state represents that the drive system is in drive stoppage.

7. The information processing apparatus according to claim 2, wherein, when the drive state represents that the drive system is in drive and the information represents that the drive system is not normally drivable during the program rewriting onto the target electric device, the processor controls the target electronic device to
perform the program rewriting, and
wait to perform a restart until the program rewriting onto the target electronic device is completed and the drive state represents that the drive system is in drive stoppage.

8. The information processing apparatus according to claim 2, wherein, when the drive state represents that the drive system is in drive stoppage and the information represents that the drive system is not normally drivable during the program rewriting onto the target electric device, the processor controls a non-target electronic device in the electronic devices to be placed in a limited state where a functional limitation is applied during the program rewriting onto the target electric device.

9. The information processing apparatus according to claim 2, wherein, when the drive state represents that the drive system is in drive stoppage and the information represents that the drive system is not normally drivable during the program rewriting onto the target electric device, the processor controls the target electronic device to
perform the program rewriting, and
perform a restart when the program rewriting onto the target electronic device is completed.

10. The information processing apparatus according to claim 2, wherein, when the drive state represents that the drive system is in drive stoppage and the information represents that the drive system is normally drivable during the program rewriting onto the target electric device, the processor controls the target electronic device to perform the program rewriting.

11. The information processing apparatus according to claim 10, wherein, when the drive state represents that the drive system is in drive stoppage and the information represents that the drive system is normally drivable during the program rewriting onto the target electric device, the processor controls the target electronic device to
perform the program rewriting, and
perform a restart when the program rewriting onto the target electronic device is completed.

12. The information processing apparatus according to claim 10, wherein, when the drive state represents that the drive system is in drive stoppage and the information represents that the drive system is normally drivable during the program rewriting onto the target electric device, the processor controls a non-target electronic device in the electronic devices to be placed in a limited state where a functional limitation is applied during the program rewriting onto the target electric device.

13. The information processing apparatus according to claim 2, wherein the processor is configured to control a power supply to start supplying power to the target electronic device before the program rewriting is performed, when power is not supplied to the target electronic device.

14. A computer program product comprising a non-transitory computer-readable recording medium on which an executable program is recorded, the program instructing a computer to carry out:
acquiring a drive state of a drive system that is provided with electronic devices; and
controlling, based on the drive state of the drive system, program rewriting onto a target electronic device included in the electronic devices.

15. An information processing system mounted on a drive system, the information processing system comprising:
electronic devices; and
an information processing apparatus configured to communicate with the electronic devices, the information processing apparatus including a memory and a processor coupled to the memory, the processor being configured to
acquire a drive state of the drive system, and
control, based on the drive state of the drive system, program rewriting onto a target electronic device included in the electronic devices.
